(19) United States
(12) Patent Application Publication
(10) Pub. No.: US 2008/0146336 A1
(43) Pub. Date: Jun. 19, 2008

(54) Exercise Gaming Device and Method of Facilitating User Exercise During Video Game Play

(76) Inventors: Philip Feldman, Catonsville, MD (US); Greg Merril, Bethesda, MD (US); Jason Grimm, Owings Mills, MD (US)

Correspondence Address: EDELL, SHAPIRO & FINNAN, LLC, 1901 RESEARCH BOULEVARD, SUITE 400, ROCKVILLE, MD, 20850, US

(21) Appl. No.: 11/930,642

(22) Filed: Oct. 31, 2007

Related U.S. Application Data
(63) Continuation-in-part of application No. 11/238,127, filed on Sep. 29, 2005.
Application No. 11/238,127 is a continuation-in-part of application No. 10/975,185, filed on Oct. 28, 2004.
Application No. 10/975,185 is a continuation-in-part of application No. 10/806,280, filed on Mar. 23, 2004.
Application No. 10/806,280 is a continuation-in-part of application No. 10/309,565, filed on Dec. 4, 2002, now Pat. No. 7,121,982.
(60) Provisional application No. 60/514,897, filed on Oct. 29, 2003.
(60) Provisional application No. 60/614,982, filed on Oct. 4, 2004.
(60) Provisional application No. 60/968,162, filed on Aug. 27, 2007.

(51) Int. Cl. A63F 13/06

(52) U.S. Cl. 463/37

(57) ABSTRACT

The present invention embodiments promote performance of exercise by users during a video or computer game by enabling a user to perform exercises to interact with the game. An embodiment of the present invention includes an exercise gaming device with a plurality of effector or gripping members in the form of handles to be manipulated by a user. The exercise gaming device further includes additional input devices to interact with a simulation or gaming scenario. The user applies forces to the handles to interact with the gaming scenario, thereby requiring the user to perform exercises during game play. The exercise gaming device may employ various damping mechanisms to provide resistance to the handles for the user. Alternatively, the handles may be fixedly attached to the exercise gaming device to resist the applied forces and provide isometric exercises for the user.

### CROSS-REFERENCE TO RELATED APPLICATIONS

This application is a Continuation-In-Part of U.S. patent application Ser. No. 11/238,127, entitled “Game Controller with Force Sensing Input Devices and Method of Measuring Applied Forces to Game Controller Input Devices to Interact with a Gaming Application” and filed Sep. 29, 2005 (U.S. Patent Application Publication No. 2006/0097453), which is a Continuation-In-Part of U.S. patent application Ser. No. 10/975,185, entitled “Configurable Game Controller and Method of Selectively Assigning Game Functions to Controller Input Devices” and filed Oct. 28, 2004 (U.S. Patent Application Publication No. 2005/0130742), which is a Continuation-In-Part of U.S. patent application Ser. No. 10/806,280, entitled “Game Controller Support Structure and Isometric Exercise System and Method of Facilitating User Exercise During Game Interaction” and filed Mar. 23, 2004 (U.S. Patent Application Publication No. 2004/0180719), which is a Continuation-In-Part of U.S. patent application Ser. No. 10/309,565, entitled “Computer Interactive Isometric Exercise System and Method for Operatively Interconnecting the Exercise System to a Computer System for Use as a Peripheral” and filed Dec. 4, 2002, now U.S. Pat. No. 7,121,982. Further, U.S. patent application Ser. Nos. 10/975,185 and 10/806,280 further claim priority from U.S. Provisional Patent Application Ser. No. 60/514,897, entitled “Configurable Game Controller and Method of Selectively Assigning Game Functions to Controller Input Devices” and filed Oct. 29, 2003. Moreover, U.S. patent application Ser. No. 11/238,127 claims priority from U.S. Provisional Patent Application Ser. No. 60/614,982, entitled “Game Controller with Force Sensing Input Devices and Method of Measuring Applied Forces to Game Controller Input Devices to Interact with a Gaming Application” and filed Oct. 4, 2004. In addition, the present application claims priority from U.S. Provisional Patent Application Ser. No. 60/968,162, entitled “Exercise Gaming Peripheral and Method of Facilitating User Exercise During Video Game Play” and filed Aug. 27, 2007. The disclosures of the above-identified patent, patent applications and patent application publications are incorporated herein by reference in their entireties.

### BACKGROUND OF THE INVENTION

1. Technical Field

The present invention embodiments relate to game controllers of the types disclosed in U.S. Pat. No. 7,121,982 (Feldman). In particular, the present invention embodiments pertain to an exercise gaming device for a gaming or simulation system to enable users to interact with video games or simulations and exercise during game play or simulation interaction.

2. Discussion of the Related Art

Currently, a wide variety of different types of exercise devices are commonly utilized to promote health and fitness, particularly for people having sedimentary lifestyles and/or work environments, and to provide rehabilitation for particular types of injuries. The vast majority of these exercise devices utilize isokinetic and/or isotonic forms of exercise during operation, where a user's muscles are moved under resistance through a selected range of motion.

Isometric exercise is another effective form of muscular exercise that is very useful for rehabilitation, fitness and/or training. For example, isometric training is useful for fighter jet pilots who perform isometric muscular contractions of the lower limbs and body core during flights to prevent blackouts when subjected to high gravitational forces. Isometric exercise involves the exertion of force by a user against an object that significantly resists movement as a result of the exerted force such that there is substantially minimal or no movement of the user's muscles during the force exertion. Examples of simple forms of isometric exercise include pushing against a stationary surface (e.g., a doorframe or a wall), attempting to pull apart tightly gripped hands or to bend or flex a sufficiently rigid steel bar, etc. Due to their inherently tedious nature, isometric exercise devices are less popular and, accordingly, are limited in type and availability, in comparison to more conventional forms of isotonic and isokinetic exercise devices.

Despite the availability of the exercise devices described above, people may not be performing a sufficient amount of exercise for good health. The lack of sufficient exercise may be attributed in part to the increasingly popularity of video and computer games. The operation of video and computer games is generally performed by users in a sitting or reclining position (e.g., on a couch, chair, floor, etc.), typically for extended periods of time. Thus, the use of video games tends to decrease the available time for and amount of exercise performed by users. This decreased amount of exercise is typically detrimental to good health and may contribute to a growing population of overweight people or even an epidemic of obesity.

### SUMMARY OF THE INVENTION

Accordingly, the present invention embodiments promote performance of exercise by users during a video or computer game. The present invention embodiments enable a user to perform exercises to interact with the game, thereby facilitating exercise and consumption of an increased quantity of calories during game play. An embodiment of the present invention includes a gaming device with a plurality of effector or gripping members in the form of handles to be manipulated by a user. The device further includes additional input devices to interact with a simulation or gaming scenario. The user applies forces to the handles to interact with the gaming scenario, thereby requiring the user to perform exercises during game play. The device may employ various damping mechanisms to provide resistance to the handles for the user. Alternatively, the handles may be fixedly attached to the device to resist the applied forces and provide isometric exercises for the user. The device further provides real world resistance for the user to enhance realism of the game.

The above and still further features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is an exploded view in elevation of an exercise gaming device coupled to a gaming system according to an embodiment of the present invention.

FIG. 2 is an exploded view in perspective of the exercise gaming device of FIG. 1.

FIG. 3 is a view in elevation of the damping assembly of the exercise gaming device of FIG. 1 illustrating the effect of a pulling force applied to effector members.

FIG. 4 is view in elevation of the damping assembly of the exercise gaming device of FIG. 1 illustrating the effect of a pushing force applied to effector members.

FIG. 5 is an exploded view in elevation of an exercise gaming device coupled to a gaming system according to another embodiment of the present invention.

FIG. 6 is a view in elevation and partial section of an alternative embodiment of an effector for the exercise gaming device of FIG. 5.

FIG. 7 is a view in elevation and partial section of yet another alternative embodiment of the effector for the exercise gaming device of FIG. 5.

FIG. 8 is a view in perspective of still another alternative embodiment of the effector for the exercise gaming device of FIG. 5.

FIG. 9 is a view in perspective of a further alternative embodiment of the effector for the exercise gaming device of FIG. 5.

FIG. 10 is a view in perspective of yet another alternative embodiment of the effector for the exercise gaming device of FIG. 5.

FIG. 11 is a view in perspective of still another alternative embodiment of the effector for the exercise gaming device of FIG. 5.

FIG. 12 is a view in perspective of a further alternative embodiment of the effector for the exercise gaming device of FIG. 5.

FIG. 13 is a view in elevation of an exercise gaming device providing a gaming scenario and coupled to a display device according to another embodiment of the present invention.

FIG. 14 is a schematic block diagram of an exemplary exercise gaming device control circuit according to an embodiment of the present invention.

### DETAILED DESCRIPTION OF THE PREFERRED EMBODIMENTS

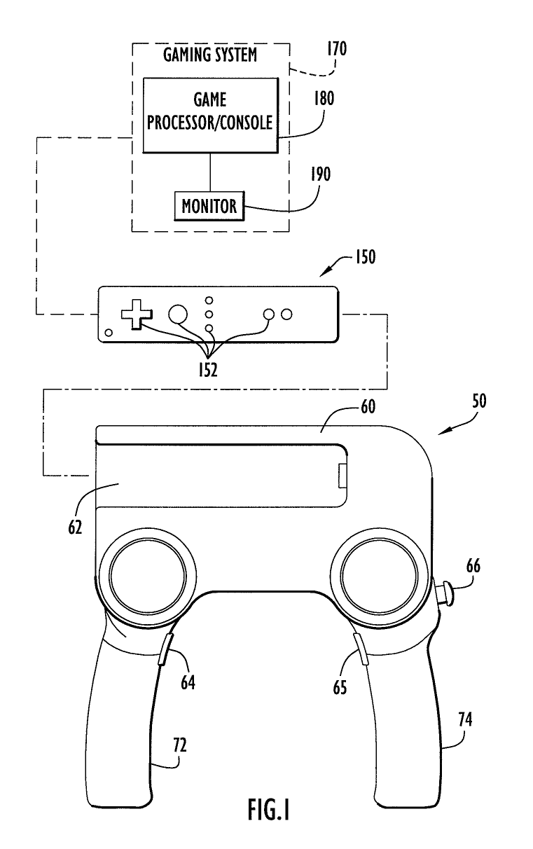

An exercise gaming device according to an embodiment of the present invention is illustrated in FIG. 1. Initially, an exercise gaming device 50 according to a present invention embodiment is preferably coupled to a game controller 150. The game controller communicates with a gaming system 170, preferably in a wireless fashion. The gaming system typically includes a game processor or console 180 and a monitor or display device 190. The game processor includes a storage drive and/or unit to receive computer readable media (e.g., CD, DVD, etc.) containing software for various games and a processing device to execute the software to provide games on the display device. The gaming system may be implemented by any conventional or other processing or gaming system (e.g., microprocessor system, personal computer, video gaming system, etc.). By way of example, gaming system 170 is implemented by the WII gaming system available from NINTENDO, where game controller 150 includes a NINTENDO WII type controller with a wireless interface to the WII gaming system. The game controller may be of the type disclosed in U.S. Patent Application Publication No. 2007/0072680 (Ikeda), the disclosure of which is incorporated herein by reference in its entirety.

The games provided by gaming system 170 generally include characters or objects that are controlled by a user via game controller 150. For example, the user may control movement and actions of a character or a vehicle (e.g., car, airplane, boat, etc.) to move through a virtual or computer-generated environment displayed on the display device. Game controller 150 includes a plurality of input devices 152 (e.g., joystick, buttons, etc.) to enable a user to interact with the game and ports for various controller peripherals. Gaming system 170 receives signals from game controller 150 and updates display device 190 to reflect the movements and/or actions of the character or object as indicated by user manipulation of the game controller.

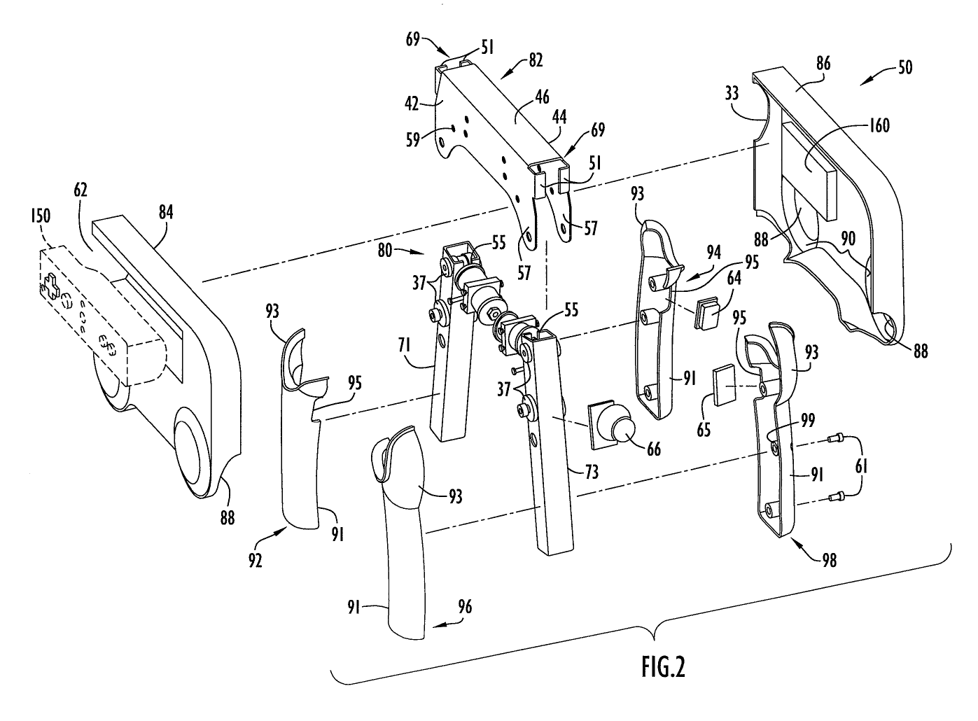

Exercise gaming device 50 serves as a hand-held peripheral to the game controller and enables a user to perform exercises to control the gaming scenario. In particular, exercise gaming device 50 includes a housing 60 and effector members 72, 74. The housing is generally rectangular with effector members 72, 74 each disposed toward a respective housing lower portion side edge and extending from the housing bottom. The housing upper portion includes a controller port 62 and control circuitry 160 (FIG. 2). The dimensions of the controller port are sufficient to removably receive game controller 150 therein, where the controller port couples the game controller to the control circuitry for interaction with gaming system 170 as described below. Game controller 150 is positioned within controller port 62 in a manner enabling the functions of the game controller (e.g., IR camera, input devices 152, etc.). A release mechanism (not shown) enables detachment of game controller 150 from controller port 62. By way of example, exercise gaming device 50 is coupled to a peripheral port (e.g., a port for a NINTENDO NUNCHUCK peripheral) of game controller 150.

Trigger type input devices 64, 65 are respectively disposed on the facing surfaces of the upper portions of effector members 72, 74 and enable interaction with gaming system 170. By way of example only, trigger devices 64, 65 respectively correspond to the ‘C’ and ‘Z’ inputs of the NINTENDO NUNCHUCK peripheral. In addition, the upper portion of effector member 74 includes a joystick or thumbstick 66 disposed on the surface opposing trigger 65 to enable further interaction with gaming system 170.

A user grips and applies force to effector members 72, 74 in order to direct the effector members toward (e.g., applying a pushing force) and away (e.g., applying a pulling force) from each other as described below. The amount of force applied to the effector members is measured to control the gaming scenario displayed on display device 190 and provided by gaming system 170. This basically requires the user to perform exercise in order to interact with the gaming scenario.

Referring to FIG. 2, housing 60 includes front and rear housing shell members 84, 86. The front and rear housing shell members are generally rectangular and each includes a pair of substantially frusto-conical recesses 88 defined in that shell member interior surface. The recesses are disposed toward corresponding opposing side edges of the lower portions of front and rear shell members 84, 86 to enable movement of effector members 72, 74 as described below. Controller port 62 is defined in an upper portion of front shell member 84, while rear shell member 86 includes a corresponding recess 33 defined in the side edge of the upper portion of the rear shell member to accommodate the controller port when the front and rear shell members are coupled together. Rear shell member 86 further houses control circuitry 160. The front and rear housing shell members are coupled together and define a housing interior.

Exercise gaming device 50 further includes a damping assembly 80 to resist forces applied by a user (or provide resistance) to effector members 72, 74. The damping assembly is partially housed within a chassis 82 and includes bar or handles 71, 73 that form a portion of effector members 72, 74 and receive forces from a user. Chassis 82 includes front and rear panels 42, 44 coupled to a top panel 46 collectively defining a chassis interior. The front and rear panels are each generally rectangular with a recessed or tapered intermediate bottom edge portion, thereby forming projections 57 toward the lower portion side edges of the front and rear panels. Bars 71 and 73 are received between projections 57 of the front and rear panels, while a stop flange 69 is disposed at each of the chassis upper portion opposing side edges to form a stop for bars 71, 73 as described below. Stop flange 69 includes projections 51 in facing relation with each projection extending from a corresponding upper portion side edge of front and rear panels 42, 44. A series of openings 59 are defined in the front and rear panels to secure damping assembly components to the chassis. The chassis upper portion is disposed within the housing interior defined by housing shell members 84, 86. The damping assembly resists forces applied by the user to the effector members as described below.

Effector member 72 includes front and rear effector coverings 92, 94. Each covering includes a semi-cylindrical body 91 with a tapered or cut-away semi-spherical upper portion 93. The front and rear coverings are coupled together and encompass handle 71 of damping assembly 80 to form effector member 72. Specifically, projections 57 of chassis 82 that receive bar 71 extend downward from the chassis portion disposed between housing shell members 84, 86. The projections extend between respective effector coverings 92, 94 to secure bar 71 therebetween. The front and rear coverings each include a plurality of posts 99 attached to the interior surfaces of those coverings. The posts of the front and rear coverings are aligned with each other and include channels defined therein to receive fasteners 61 to secure the front and rear coverings together. The posts are positioned within the coverings to secure bar 71 therein and enable movement of the bar in response to user manipulation of effector member 72.

Semi-cylindrical portions 91 of front and rear coverings 92, 94 form a substantially cylindrical body when the front and rear coverings are coupled together, and basically serve as a handle for engagement by a user. A generally U-shaped recess 95 is defined in an upper portion of the body side edge of coverings 92, 94. Recesses 95 of coverings 92, 94 form an opening of sufficient size to accommodate trigger 64 when the front and rear coverings are coupled together. Upper portions 93 of coverings 92, 94 are disposed within corresponding recesses 88 of front and rear housing shell members 84, 86. Recesses 88 each include a substantially circular channel 90 defined therein to receive and guide upper portion 93 of a corresponding cover member. The cover members basically traverse channels 90 in response to force applied by the user to enable effector member 72 to move relative to housing 60.

Effector member 74 is substantially similar to effector member 72 and includes front and rear effector coverings 96, 98. The coverings are substantially similar to coverings 92, 94 described above and each includes semi-cylindrical body 91 with tapered or cut-away semi-spherical upper portion 93. The front and rear coverings are coupled together and encompass handle 73 of damping assembly 80 to form effector member 74. Specifically, projections 57 of chassis 82 that receive bar 73 extend downward from the chassis portion disposed between housing shell members 84, 86. The projections extend between respective effector coverings 96, 98 to secure bar 73 therebetween. Coverings 96, 98 are coupled in a manner to accommodate joystick 66 preferably disposed on bar 73 (e.g., the coverings may form a slot or other opening to accommodate the thumbstick, etc.). The front and rear coverings each include posts 99 attached to the interior surfaces of those coverings. The posts of front and rear coverings 96, 98 are aligned with each other and include channels defined therein to receive fasteners 61 to secure the front and rear coverings together. The posts are positioned within the coverings to secure bar 73 therein and enable movement of the bar in response to user manipulation of effector member 74.

Semi-cylindrical portions 91 of front and rear coverings 96, 98 form a substantially cylindrical body when the front and rear coverings are coupled together, and basically serve as a handle for engagement by a user. Generally U-shaped recess 95 is defined in an upper portion of the body side edge of coverings 96, 98. Recesses 95 of coverings 96, 98 form an opening of sufficient size to accommodate trigger 65 when the front and rear coverings are coupled together. Upper portions 93 of coverings 96, 98 are disposed within corresponding recesses 88 of front and rear housing shell members 84, 86. Recesses 88 each include channel 90 defined therein to receive and guide upper portion 93 of a corresponding cover member. The cover members basically traverse channels 90 in response to force applied by the user to enable effector member 74 to move relative to housing 60.

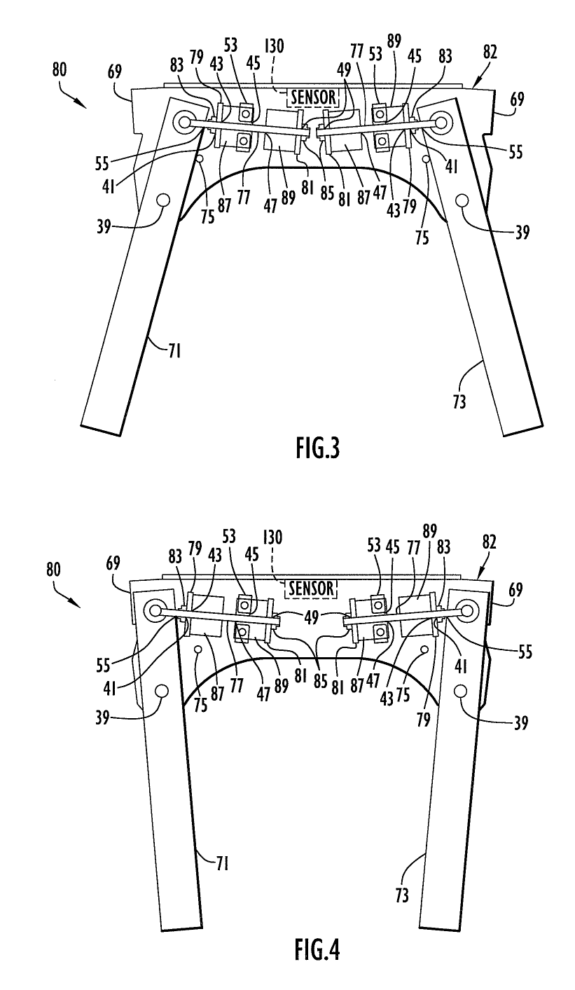

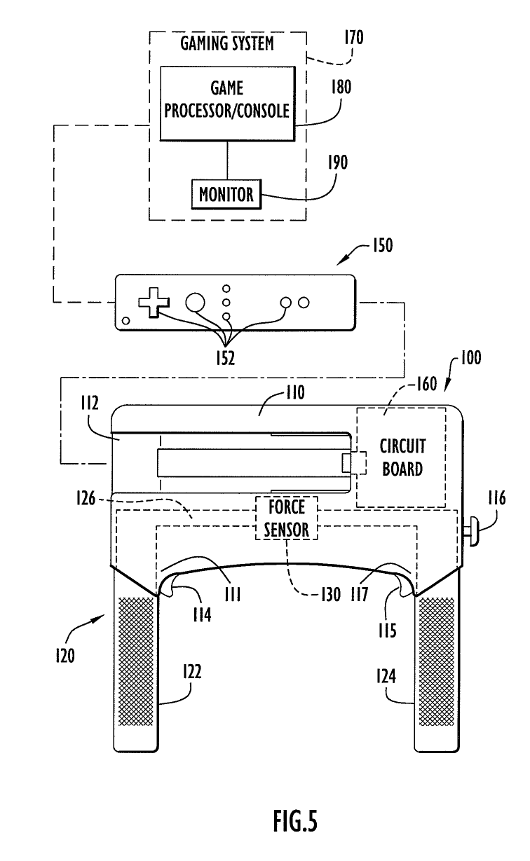

The damping assembly of exercise gaming device 50 is illustrated in FIGS. 3-4. Specifically, damping assembly 80 is housed within chassis 82 as described above and resists forces applied to effector members 72, 74 by the user. Bars 71, 73 of the effector members are coupled to a mechanical arrangement providing a damping force to resist movement of the effector members by the user. The mechanical arrangement is described with respect to bar 71 and effector member 72. However, this mechanical arrangement is similarly applied to bar 73 and effector member 74. Specifically, bar 71 includes a generally rectangular transverse cross-section. The bar is secured to and between projections 57 of chassis 82 via a suitable fastener 39 inserted through the bar upper portion and corresponding chassis openings 59. Fastener 39 basically serves as the axis of rotation for the bar. Since chassis 82 is preferably constructed of metal or other rigid material, bar 71 may include a pad or buffer 37 (FIG. 2) disposed at the upper and/or intermediate bar portions to reduce friction between bar 71 and chassis 82 during rotation of the bar about fastener 39. Further, chassis 82 includes a dowel pin 75 disposed adjacent bar 71. The dowel pin and corresponding stop flange 69 serve as stops for bar 71 as described below.

Bar 71 includes an opening or slot 55 (FIG. 2) defined therein toward a bar upper portion. A threaded bolt 77 is inserted through opening 55 and extends into the chassis interior. A generally annular washer 79 is disposed adjacent the exterior surface of bar 71. Washer 79 includes an opening 41 substantially aligned with slot 55 to receive the bolt therethrough. In order to provide resistive forces to movement of bar 71 (or effector member 72) by a user, a compressible ring 87 is disposed along bolt 77 with washer 79 arranged between the ring and bar 71. The ring includes an opening 43 substantially aligned with slot 55 and opening 41 to receive the bolt therethrough. A generally rectangular divider 53 is fixedly secured to chassis 82 and includes an opening 45 substantially aligned with slot 55 and openings 41 and 43 to receive bolt 77 therethrough. The divider is disposed along the bolt with compressible ring 87 disposed between the divider and washer 79. Thus, washer 79 and divider 53 serve as stops to facilitate compression of compressible ring 87. A nut 83 is disposed on the bolt between bar 71 and washer 79 to enable washer 79 to compress ring 87 against stationary divider 53 in response to pulling forces applied to bar 71 as described below.

A compressible ring 89 is further disposed along bolt 77 with divider 53 arranged between compressible rings 87, 89. Ring 89 includes an opening 47 substantially aligned with slot 55 and openings 41, 43 and 45 to receive the bolt therethrough. A washer 81 is disposed adjacent ring 89, where washer 81 includes an opening 49 substantially aligned with slot 55 and openings 41, 43, 45 and 47 to receive the bolt therethrough. Thus, washer 81 and divider 53 serve as stops to facilitate compression of compressible ring 89. A nut 85 is disposed at the end of the bolt adjacent washer 81 to enable washer 81 to compress ring 89 against stationary divider 53 in response to pushing forces applied to bar 71 as described below. The dimensions of openings 41, 43, 45, 47, 49 and 55 are slightly greater than the transverse cross-sectional dimensions of bolt 77, while the dimensions of nuts 83, 85 are slightly greater than those of washer openings 41, 49 to urge the washers against the rings.

When the user applies a pulling or pushing force to bar 71 of effector member 72, the effector member rotates about fastener 39 and encounters resistive forces. For example, a pulling force applied to bar 71 urges the bar upper portion and bolt 77 toward the chassis interior. This forces washer 79 to compress ring 87 against stationary divider 53 (FIG. 3). Dowel pin 75 serves as a stop for bar 71 when the applied pulling force exceeds an amount (e.g., thirty to fifty pounds) to sufficiently compress ring 87. The ring compression and/or dowel pin provide resistance to the user manipulation of effector member 72. A similar process is performed for bar 73 in response to bar 73 receiving a pulling force.

A pushing force applied to bar 71 urges the bar upper portion and bolt 77 toward the chassis side edge. This forces washer 81 to compress ring 89 against stationary divider 53 (FIG. 4). Stop flange 69 serves as a stop for bar 71 when the applied pushing force exceeds an amount (e.g., thirty to fifty pounds) to sufficiently compress ring 89. The ring compression and/or stop flange provide resistance to the user manipulation of effector member 72. A similar process is performed for bar 73 in response to bar 73 receiving a pushing force. Compressible rings 87, 89 are preferably constructed of rubber or urethane (e.g., materials utilized for skateboard trucks, etc.) to control the range of motion and provide resistance (e.g., the resistance increases as the rings are compressed), but may be constructed of any suitable compressible materials.

The resistance provided by the mechanical arrangement of damping assembly 80 applies force to chassis 82 to slightly bend or deflect the chassis. Accordingly, chassis 82 further includes one or more force sensors 130 preferably disposed on the interior surface of rear panel 44. The force sensors are typically in the form of strain gauges, but may be implemented by any conventional or other force measuring devices (e.g., pressure sensor, accelerometer, etc.). Force sensors 130 measure the force applied by the user to exercise gaming device 50 and provide measurement signals (e.g., analog, digital, etc.) to control circuitry 160 for processing as described below. By way of example, the force sensors measure the amount of a strain deformation applied to the chassis as a result of the user applying pushing, pulling or lateral forces to the effector members. The deformity measurement may be based on a change in resistance or other property of the chassis measured by the force sensors. Exercise gaming device 50 preferably measures pulling and pushing forces applied to the effector members by the user in the approximate range of two to one-hundred pounds (e.g., 2-100 pounds) and may withstand maximum applied forces of approximately two-hundred fifty pounds. However, exercise gaming device 50 may be configured for any desired or suitable applied forces.

Alternatively, exercise gaming device 50 may include bars 71, 73 directly and fixedly attached to chassis 82 (without damping assembly 80). In this case, the bars provide an isometric exercise, where force applied by the user to the effector members bends or deforms chassis 82 and/or bars 71, 73. Force sensors 130 may be disposed on the chassis and/or bars to measure the bend or deformity from the applied force and provide information to control circuitry 160 to control the simulation or gaming scenario.

One or more force sensors 130 may be disposed on the chassis or bars 71, 73 at any suitable locations to measure force along various effector member axes, thereby providing an indication of the direction or type of force applied (e.g., pushing, pulling, twisting, etc.). For example, two force sensors may be applied along different axes (e.g., X and Y axes) of the chassis and/or bars to respectively measure pulling and pushing forces applied to the effector members. The control circuitry processes the force measurements and provides information in substantially the same format as a game controller peripheral (e.g., NINTENDO NUNCHUCK peripheral) to game controller 150 for transmission to gaming system 170. By way of example, since the NINTENDO NUNCHUCK peripheral provides acceleration information to the NINTENDO WII game controller, force measurements from exercise gaming device 170 are provided in a format of the NINTENDO NUNCHUCK peripheral acceleration information to be compatible with game controller 150. Gaming system 170 typically includes an accumulation buffer for the gaming scenario to sum the force measurements and determine the applied force for each direction (e.g., pulling, pushing, etc.). In addition, information pertaining to manipulation of triggers 64, 65 and joystick 66 is provided to game controller 150 in a format similar to the format for input devices of a game controller peripheral (e.g., NINTENDO NUNCHUCK peripheral).

Game controller 150 typically includes a sensing arrangement (e.g., accelerometer, infrared triangulation system, etc.) to measure the orientation (e.g., plural degree-of-freedom, etc.) of the game controller. Since the game controller is embedded in exercise gaming device 50 as described above, the sensing arrangement measures the orientation (e.g., along X, Y and Z axes, twist, etc.) of the exercise gaming device. Alternatively, the sensing arrangement may be disposed within housing 60 of exercise gaming device 50 to measure the exercise gaming device orientation. The orientation measurements may be utilized to provide directional controls for the gaming scenario (e.g., steering, etc.).

The force information (and information pertaining to manipulation of triggers 64, 65 and joystick 66) from exercise gaming device 50 and orientation and input device (e.g., input devices 152) information measured by game controller 150 are transmitted from the game controller to gaming system 170. The gaming system updates the gaming scenario and display device 190 in accordance with the received information. Thus, user manipulation of the effector members enables the user to interact with the gaming scenario (e.g., controls an object or some action in the gaming scenario). In other words, the greater the force applied to exercise gaming device 50, the greater the effect within the gaming scenario. The gaming scenarios utilized with exercise gaming device 50 typically require the user to apply force to the effector members (e.g., pull, compress, etc.) in a variety of different orientations to access different muscles and achieve goals in the gaming scenario. In addition, exercise gaming device 50 includes a dynamic calibration to control the amount of force required by a user in order to interact with the gaming scenario as described below.

An exercise gaming device according to another embodiment of the present invention is illustrated in FIG. 5. Initially, an exercise gaming device 100 according to a present invention embodiment is preferably coupled to game controller 150 described above. The game controller communicates with gaming system 170, preferably in a wireless fashion as described above. The gaming system typically includes game processor or console 180 and monitor or display device 190 as described above. The game processor includes a storage drive and/or unit to receive computer readable media (e.g., CD, DVD, etc.) containing software for various games and a processing device to execute the software to provide games on the display device as described above.

The games provided by gaming system 170 generally include characters or objects that are controlled by a user via game controller 150 as described above. For example, the user may control movement and actions of a character or a vehicle (e.g., car, airplane, boat, etc.) to move through a virtual or computer-generated environment displayed on the display device. Game controller 150 includes a plurality of input devices 152 (e.g., joystick, buttons, etc.) to enable a user to interact with the game and ports for various controller peripherals as described above. Gaming system 170 receives signals from game controller 150 and updates display device 190 to reflect the movements and/or actions of the character or object as indicated by user manipulation of the game controller as described above.

Exercise gaming device 100 serves as a hand-held peripheral to the game controller and enables a user to perform exercises to control the gaming scenario. In particular, exercise gaming device 100 includes a housing 110 and an effector 120. The housing is generally rectangular with projections 111, 117 disposed toward opposing housing side edges. The projections each include open bottom portions and extend downward from the housing bottom portion. The housing upper portion includes a controller port 112 and control circuitry 160 disposed adjacent the controller port. The dimensions of the controller port are sufficient to removably receive game controller 150 therein, where the controller port couples the game controller to the control circuitry for interaction with gaming system 170 as described below. Game controller 150 is positioned within controller port 112 in a manner enabling the functions of the game controller (e.g., IR camera, input devices 152, etc.). A release mechanism (not shown) enables detachment of game controller 150 from controller port 112. By way of example, exercise gaming device 100 is coupled to a peripheral port (e.g., a port for a NINTENDO NUNCHUCK peripheral) of game controller 150.

Trigger type input devices 114, 115 are respectively disposed on projections 111, 117 and enable interaction with gaming system 170. By way of example only, trigger devices 114, 115 respectively correspond to the ‘C’ and ‘Z’ inputs of the NINTENDO NUNCHUCK peripheral. In addition, the upper portion of projection 117 includes a joystick or thumbstick 116 to enable further interaction with gaming system 170. Triggers 114, 115 and joystick 116 are substantially similar to corresponding triggers 64, 65 and joystick 66 described above.

Effector 120 is generally ‘U’-shaped and includes gripping members 122, 124 rigidly or fixedly attached to opposing ends of an intermediate member 126. The intermediate and gripping members are in the form of generally rectangular bars and are constructed of a suitably rigid material (e.g., a metal alloy) that is capable of being slightly deflected within its elastic limit in response to any combination of bending, twisting, tension and compression forces applied by the user to the effector. While the intermediate and gripping members are generally rectangular as described above, it is noted that these members may be of any suitable shape (e.g., bent or curved, V-shaped, cylindrical, etc.) and have any suitable exterior surface geometries (e.g., curved, multifaceted, etc.).

The intermediate member is disposed within housing 110 below controller port 112, while gripping members 122, 124 respectively extend down from the intermediate member ends through and beyond the open bottom portions of projections 111, 117. The gripping members extend beyond the open bottom portions of the projections for a distance sufficient to enable a user to grip and apply force to the gripping members.

A user grips and applies force to gripping members 122, 124 in order to direct the gripping members toward (e.g., applying a pushing force) and away (e.g., applying a pulling force) from each other. The amount of force applied to the gripping members controls the gaming scenario displayed on display device 190 and provided by gaming system 170. This basically requires the user to perform an isometric type exercise in order to interact with the gaming scenario.

Accordingly, housing 110 further includes one or more force sensors 130 preferably disposed on or adjacent intermediate member 126. The force sensors are typically in the form of strain gauges, but may be implemented by any conventional or other force measuring devices (e.g., pressure sensor, accelerometer, etc.). Force sensors 130 measure the force applied by the user to exercise gaming device 100 and provide measurement signals (e.g., analog, digital, etc.) to control circuitry 160 for processing as described below. By way of example, the force sensors measure the amount of a strain deformation applied to the intermediate member as a result of the user applying pushing, pulling or lateral forces to the gripping members. The deformity measurement may be based on a change in resistance or other property of the intermediate member measured by the force sensors. Exercise gaming device 100 preferably measures pulling and pushing forces applied to the gripping members by the user in the approximate range of two to one-hundred pounds (e.g., 2-100 pounds) and may withstand maximum applied forces of approximately two-hundred fifty pounds. However, exercise gaming device 100 may be configured for any desired or suitable applied forces.

One or more force sensors 130 may be disposed on effector 120 at any suitable locations to measure force along various effector axes, thereby providing an indication of the direction or type of force applied (e.g., pushing, pulling, twisting, etc.). For example, two force sensors may be applied along different axes (e.g., X and Y axes) of the intermediate and/or gripping members to respectively measure pulling and pushing forces applied to the gripping members. The control circuitry processes the force measurements and provides information in substantially the same format as a game controller peripheral (e.g., NINTENDO NUNCHUCK peripheral) to game controller 150 for transmission to gaming system 170. By way of example, since the NINTENDO NUNCHUCK peripheral provides acceleration information to the NINTENDO WII game controller, force measurements from exercise gaming device 170 are provided in a format of the NINTENDO NUNCHUCK peripheral acceleration information to be compatible with game controller 150. Gaming system 170 typically includes an accumulation buffer for the gaming scenario to sum the force measurements and determine the applied force for each direction (e.g., pulling, pushing, etc.). In addition, information pertaining to manipulation of triggers 114, 115 and joystick 116 is provided to game controller 150 in a format similar to the format for input devices of a game controller peripheral (e.g., NINTENDO NUNCHUCK peripheral).

Game controller 150 typically includes a sensing arrangement (e.g., accelerometer, infrared triangulation system, etc.) to measure the orientation (e.g., plural degree-of-freedom, etc.) of the game controller as described above. Since the game controller is embedded in exercise gaming device 100 as described above, the sensing arrangement measures the orientation (e.g., along X, Y and Z axes, twist, etc.) of the exercise gaming device. Alternatively, the sensing arrangement may be disposed within housing 110 of exercise gaming device 100 to measure the exercise gaming device orientation. The orientation measurements may be utilized to provide directional controls for the gaming scenario (e.g., steering, etc.).

The force information (and information pertaining to manipulation of triggers 114, 115 and joystick 116) from exercise gaming device 100 and orientation and input device (e.g., input devices 152) information measured by game controller 150 are transmitted from the game controller to gaming system 170. The gaming system updates the gaming scenario and display device 190 in accordance with the received information. Thus, user manipulation of the gripping members enables the user to interact with the gaming scenario (e.g., controls an object or some action in the gaming scenario). In other words, the greater the force applied to exercise gaming device 100, the greater the effect within the gaming scenario. The gaming scenarios utilized with exercise gaming device 100 typically require the user to apply force to the gripping members (e.g., pull, compress, etc.) in a variety of different orientations to access different muscles and achieve goals in the gaming scenario. In addition, exercise gaming device 100 includes a dynamic calibration to control the amount of force required by a user in order to interact with the gaming scenario as described below.

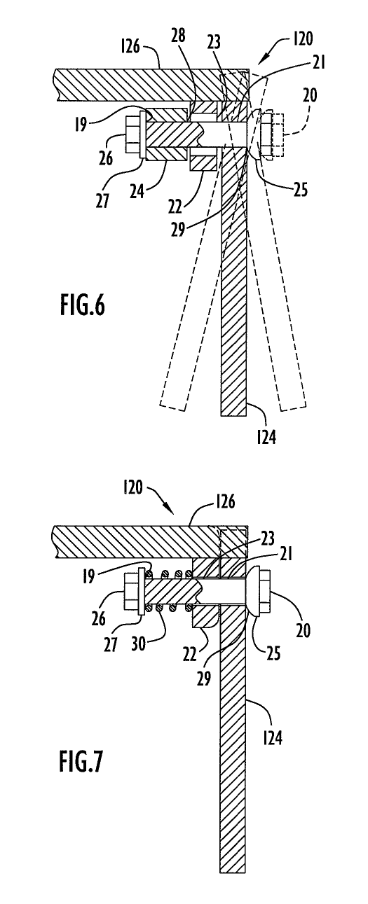

An alternative embodiment of the effector for exercise gaming device 100 is illustrated in FIG. 6. Initially, effector 120 is substantially similar to the effector described above and includes the gripping and intermediate members. The gripping members are coupled to the intermediate member by a mechanical arrangement providing a damping force to resist movement of the gripping members by a user. The mechanical arrangement is described with respect to coupling gripping member 124 to a corresponding end of intermediate member 126. However, this mechanical arrangement is similarly applied to couple gripping member 122 (not shown) to the opposing end of intermediate member 126. Specifically, intermediate member 126 is similar to the intermediate member described above and in the form of a generally rectangular bar. The intermediate member includes a downwardly extending projection 22 disposed toward an intermediate member end. Projection 22 includes an opening or hole 23 defined therethrough, preferably toward the center of the projection. Gripping member 124 is similar to the gripping member described above and in the form of a generally rectangular bar. The gripping member includes an opening or hole 21 defined therethrough toward a gripping member upper portion. The top surface of gripping member 124 engages an end of the intermediate bar and extends downward adjacent projection 22 with openings 21, 23 substantially aligned. The projection includes dimensions significantly less than the gripping member and is basically coincident the gripping member upper portion. The gripping member may engage the intermediate bar in any suitable fashion. By way of example, a projection (not shown) on the gripping member top surface may be inserted into a complementary notch (not shown) defined in the intermediate member to reduce transverse motion of the gripping member relative to the intermediate member.

A bolt 20 is inserted through aligned openings 21, 23 to attach gripping member 124 to intermediate bar 126. A generally annular washer 25 is disposed adjacent the exterior surface of gripping member 124 with the gripping member arranged between washer 25 and projection 22. Washer 25 includes an opening 29 substantially aligned with openings 21, 23 to receive the bolt therethrough. In order to provide resistive forces to movement of gripping member 124 by a user, a compressible ring 24 is disposed along bolt 20 with projection 22 arranged between the ring and gripping member 124. The ring includes an opening 28 substantially aligned with openings 21, 23 and 29 to receive the bolt therethrough. A generally annular washer 27 is disposed along bolt 20 with compressible ring 24 disposed between washer 27 and projection 22. Thus, washer 27 and projection 22 serve as stops to facilitate compression of compressible ring 24 as described below. Washer 27 includes an opening 19 substantially aligned with openings 21, 23, 28 and 29 to receive the bolt therethrough. A nut 26 is disposed at the end of the bolt adjacent washer 27 to secure the mechanical arrangement to the effector. The dimensions of openings 21, 23, 28 and 29 are slightly greater than the transverse cross-sectional dimensions of bolt 20. This arrangement enables the bolt to be received within the openings in a slidable relation, thereby facilitating compression of compressible ring 24 as described below.

When the user applies a pulling or pushing force to gripping member 124, the gripping member pivots and applies a force to bolt 20. For example, a pushing force applied to gripping member 124 urges the gripping member lower portion toward the effector interior, while the gripping member upper portion is forced toward the effector exterior and applies a pulling force to bolt 20 to move or slide the bolt in a similar (exterior) direction. A pulling force applied to gripping member 124 urges the gripping member upper portion toward the effector interior, while the gripping member lower portion is forced toward the effector exterior. This motion similarly applies a pulling force to bolt 20 to move or slide the bolt in a direction toward the effector exterior. The compressible ring is compressed by the bolt motion (e.g., washer 27 compressing compressible ring 24 against projection 22) and provides resistance to the user manipulation of the gripping member. The compressible ring is preferably constructed of rubber (e.g., materials utilized for skateboard trucks, etc.) to control the range of motion and provide resistance (e.g., the resistance increases as the ring is compressed), but may be constructed of any suitable compressible materials. Force sensor 130 may disposed on gripping member 124 to measure the applied force (e.g., the deformity of the gripping member or compression of the compressible ring). The force measurement is provided to game controller 150 for transmission to gaming system 170 in order to update the gaming scenario. Thus, the effector basically requires the user to perform an exercise in order to interact with the gaming scenario.

Another alternative embodiment of the effector for exercise gaming device 100 is illustrated in FIG. 7. Initially, effector 120 is substantially similar to the effector described above for FIG. 6 and includes the gripping and intermediate members. The gripping members are coupled to the intermediate member by a mechanical arrangement providing a damping force to resist movement of the gripping members by a user. The mechanical arrangement is described with respect to coupling gripping member 124 to a corresponding end of intermediate member 126. However, this mechanical arrangement is similarly applied to couple gripping member 122 (not shown) to the opposing end of intermediate member 126. Specifically, intermediate member 126 is in the form of a generally rectangular bar and includes projection 22 with hole or opening 23 as described above. The projection is disposed toward an intermediate member end. Gripping member 124 is in the form of a generally rectangular bar and includes opening or hole 21 defined therethrough as described above. The top surface of gripping member 124 engages an end of the intermediate bar and extends downward adjacent projection 22 with openings 21, 23 substantially aligned as described above. By way of example, a projection (not shown) on the gripping member top surface may be inserted into a complementary notch (not shown) defined in the intermediate member to reduce transverse motion of the gripping member relative to the intermediate member as described above.

Bolt 20 is inserted through aligned openings 21, 23 to attach gripping member 124 to intermediate bar 126. Washer 25 is disposed adjacent the exterior surface of gripping member 124 with the gripping member arranged between washer 25 and projection 22 as described above. Washer opening 29 is substantially aligned with openings 21, 23 to receive the bolt therethrough as described above. In order to provide resistive forces to movement of gripping member 124 by a user, a spring 30 is disposed along bolt 20 with projection 22 arranged between the spring and gripping member 124. The spring is generally helical and extends axially from projection 22 with the spring interior substantially aligned with openings 21, 23 and 29 to receive the bolt therethrough. Washer 27 is disposed along bolt 20 with spring 30 disposed between washer 27 and projection 22. Thus, washer 27 and projection 22 serve as stops to facilitate compression of spring 30 as described below. Washer 27 includes opening 19 substantially aligned with the spring interior and openings 21, 23 and 29 to receive the bolt therethrough as described above. Nut 26 is disposed at the end of the bolt adjacent washer 27 to secure the mechanical arrangement to the effector as described above. The dimensions of the spring interior and openings 21, 23, and 29 are slightly greater than the transverse cross-sectional dimensions of bolt 20. This arrangement enables the bolt to be received within the spring interior and openings in a slidable relation, thereby facilitating compression of spring 30 as described below.

When the user applies a pulling or pushing force to gripping member 124, the gripping member pivots and applies a force to bolt 20. For example, a pushing force applied to gripping member 124 urges the gripping member lower portion toward the effector interior, while the gripping member upper portion is forced toward the effector exterior and applies a pulling force to bolt 20 to move or slide the bolt in a similar (exterior) direction. A pulling force applied to gripping member 124 urges the gripping member upper portion toward the effector interior, while the gripping member lower portion is forced toward the effector exterior. This motion similarly applies a pulling force to bolt 20 to move or slide the bolt in a direction toward the effector exterior. Spring 30 is compressed by the bolt motion (e.g., washer 27 compressing spring 30 against projection 22) and provides resistance to the user manipulation of the gripping member. The spring may be constructed of any suitable materials (e.g., metal, plastic, etc.) to control the range of motion and provide resistance. Force sensor 130 may be attached to gripping member 124 to measure the applied force (e.g., the deformity of the gripping member or the compression of the spring). The force measurement is provided to game controller 150 for transmission to gaming system 170 in order to update the gaming scenario. Thus, the effector basically requires the user to perform an exercise in order to interact with the gaming scenario.

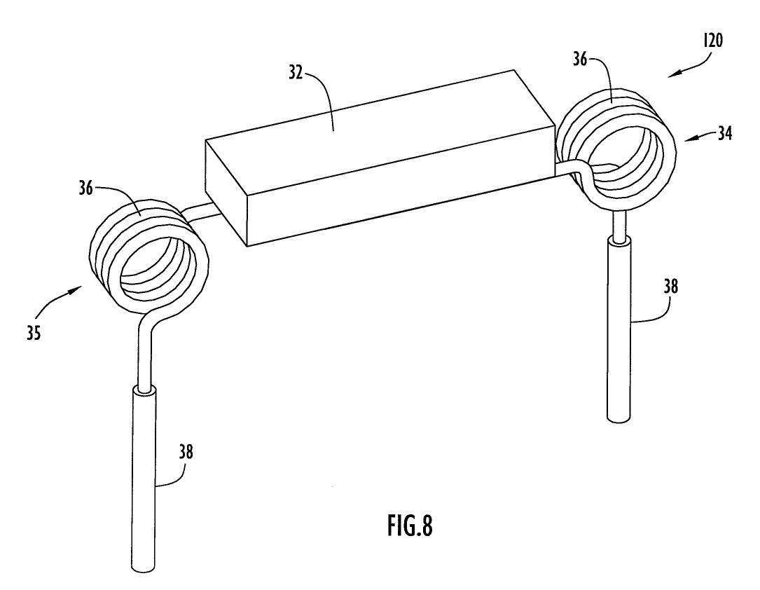

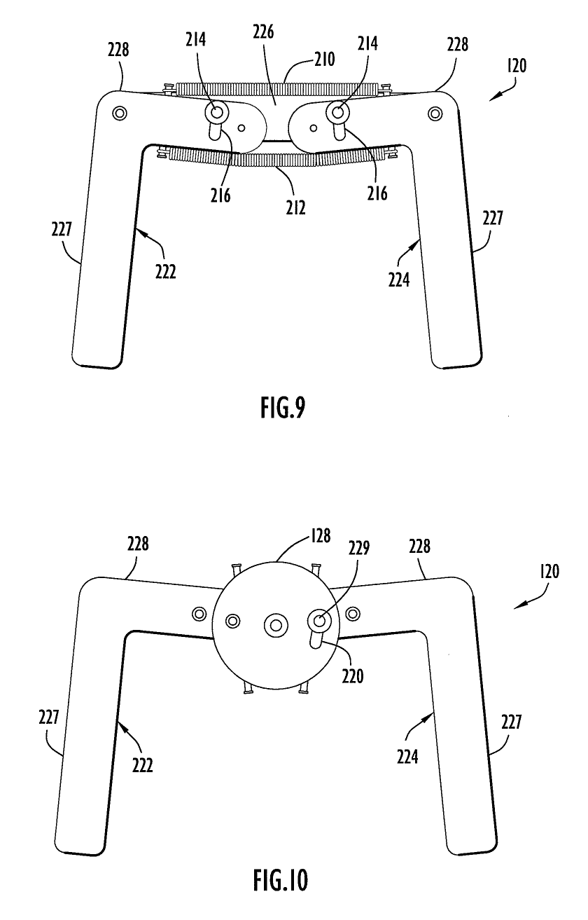

Yet another alternative embodiment of the effector for exercise gaming device 100 is illustrated in FIG. 8. Initially, effector 120 is similar to the effectors described above and includes an intermediate bar 32 and gripping members 34, 35. Intermediate bar 32 is in the form of a generally rectangular bar and includes gripping members 34, 35 each attached to a corresponding opposing bar end. The intermediate bar is constructed of a suitably rigid material (e.g., metal, steel, plastic, rubber, etc.) that is capable of being slightly deflected within its elastic limit in response to any combination of bending, twisting, tension and compression forces applied to the gripping members. Gripping members 34, 35 each include a generally helical spring 36 attached to a corresponding end of the intermediate bar, and a grip portion 38 attached to the spring for engagement by a user hand. The helical spring coils extend transversely relative to the longitudinal axis of the intermediate bar to provide resistance to the user.

When the user applies a pulling or pushing force to grip portions 38 of gripping members 34, 35, springs 36 resist the grip movement and apply force to intermediate bar 32 (e.g., deform the intermediate bar). Force sensor 130 may be attached to intermediate bar 32 to measure the applied force (e.g., the deformity of the intermediate bar). The force measurement is provided to game controller 150 for transmission to gaming system 170 in order to update the gaming scenario. Thus, the effector basically requires the user to perform an exercise in order to interact with the gaming scenario.

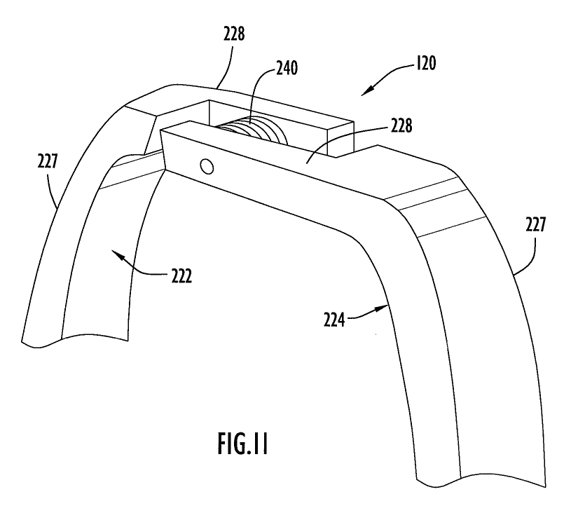

Still another alternative embodiment of the effector for exercise gaming device 100 is illustrated in FIG. 9. Specifically, effector 120 includes substantially ‘L’-shaped gripping members 222, 224 and an intermediate member 226. The gripping members each include a body or handle portion 227 engagable by a user hand and a leg portion 228 extending transversely from the body. The gripping members are arranged in an inverted position with bodies 227 substantially parallel and legs 228 in facing relation. The gripping members and intermediate member are preferably constructed of a suitably rigid material (e.g., metal, steel, plastic, rubber, etc.) that is capable of being slightly deflected within its elastic limit in response to any combination of bending, twisting, tension and compression forces applied to the gripping members. Legs 228 of gripping members 222, 224 each include a slot 216 and are secured to intermediate member 226 via fasteners 214 inserted through the slots. The dimensions of the slots exceed those of the fasteners to enable the fasteners to slide within the slots. Upper and lower springs 210, 212 are respectively secured to the upper and lower surfaces of legs 228 and are disposed between gripping members 222, 224 to provide resistance to user forces applied to the gripping members.

When the user applies a pulling force to gripping members 222, 224, bodies 227 extend outward, while fasteners 214 slide within slots 216 toward the upper portion of the slots and enable legs 228 to move slightly inward. The outward movement of bodies 227 expands lower spring 212, and the inward movement of legs 228 compresses upper spring 210. In response to a pushing force applied to gripping members 222, 224, bodies 227 extend inward, while fasteners 214 slide within slots 216 toward the lower portion of the slots and enable legs 228 to move slightly outward. The inward movement of bodies 227 compresses lower spring 212, and the outward movement of legs 228 expands upper spring 210. The compression and expansion of the upper and lower springs resist the gripping member movement and apply force to the intermediate member (e.g., deform the intermediate member and/or gripping members). Force sensors 130 may be attached to gripping members 222, 224 and/or intermediate member 226 to measure the applied force (e.g., the deformity of the gripping members and/or intermediate member). The force measurement is provided to game controller 150 for transmission to gaming system 170 in order to update the gaming scenario. Thus, the effector basically requires the user to perform an exercise in order to interact with the gaming scenario.

A further alternative embodiment of the effector for exercise gaming device 100 is illustrated in FIG. 10. Initially, effector 120 is similar to the effector described above for FIG. 9 and includes gripping members 222, 224 as described above and a pivot member 128. The gripping members each include body or handle portion 227 engagable by a user hand and leg portion 228 as described above. The gripping members are arranged in an inverted position with bodies 227 substantially parallel and legs 228 in facing relation as described above. Pivot member 128 includes a slot 220 and is secured to leg 228 of gripping member 224 via a fastener 229 inserted through the slot. The dimensions of the slot exceed those of the fastener to enable the fastener to slide within the slot. Leg 228 of gripping member 222 is fixedly secured to an opposing end of pivot member 128. The pivot member enables gripping member 224 to pivot relative to gripping member 222 and provides resistance to user forces applied to the gripping members. The gripping and pivot members are preferably constructed of a suitably rigid material (e.g., metal, steel, plastic, rubber, etc.) that is capable of being slightly deflected within its elastic limit in response to any combination of bending, twisting, tension and compression forces applied to the gripping members.

When the user applies a pulling force to gripping members 222, 224, pivot member 128 rotates and fastener 229 slides within slot 220 toward the upper portion of the slot, where the slot serves as a stop to restrict motion of gripping members 222, 224 and apply force to the pivot member (e.g., deform the pivot member and/or gripping members). In response to a pushing force applied to gripping members 222, 224, pivot member 128 rotates and fastener 229 slides within slot 220 toward the lower portion of the slot, where the slot serves as a stop to restrict motion of gripping members 222, 224 and apply force to the pivot member (e.g., deform the pivot member and/or gripping members). Force sensors 130 may be attached to gripping members 222, 224 and/or pivot member 128 to measure the applied force (e.g., the deformity of the gripping members and/or pivot member). The force measurement is provided to game controller 150 for transmission to gaming system 170 in order to update the gaming scenario. Thus, the effector basically requires the user to perform an exercise in order to interact with the gaming scenario.

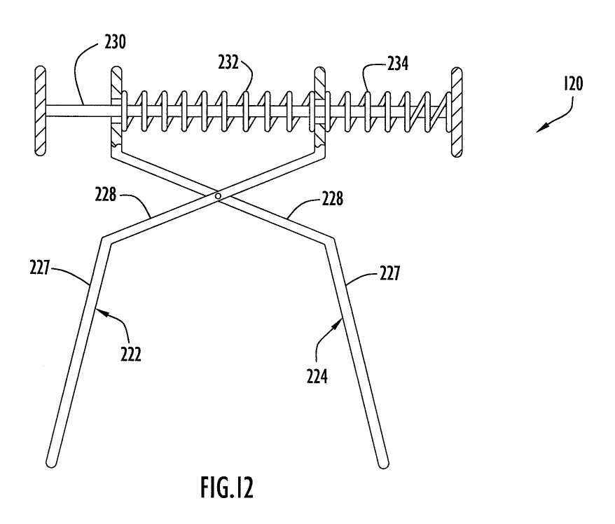

Yet another alternative embodiment of the effector for exercise gaming device 100 is illustrated in FIG. 11. Initially, effector 120 is similar to the effectors described above and includes gripping members 222, 224 substantially similar to gripping members 222, 224 described above. The gripping members each include body or handle portion 227 engagable by a user hand and leg portion 228 extending transversely from the body. The gripping members are arranged in an inverted position with bodies 227 substantially parallel. Legs 228 of gripping members 222, 224 are configured to enable the legs to be arranged in a mated or overlapping fashion enabling rotation of overlapping or mated legs 228 relative to each other. The gripping members are preferably constructed of a suitably rigid material (e.g., metal, steel, plastic, rubber, etc.) that is capable of being slightly deflected within its elastic limit in response to any combination of bending, twisting, tension and compression forces applied to the gripping members.

A resistive member 240 is disposed between and coupled to legs 228 of gripping members 222, 224. The resistive member may be housed within a suitable housing and provides resistance to user forces applied to the gripping members. The resistive member preferably includes a torsion spring to resist rotation of the gripping member legs. Alternatively, resistive member 240 may include a series of meshed gears to provide the resistance.

When the user applies a pulling or pushing force to gripping members 222, 224, overlapping or mated legs 228 rotate relative to each other (and about an axis transverse to the legs and passing through resistive member 240). The resistive member (e.g., torsion spring or meshed gears) resists the leg rotation to provide resistance to the forces applied to gripping members 222, 224. Force sensors 130 may be attached to gripping members 222, 224 to measure the applied force (e.g., the deformity of the gripping members). The force measurement is provided to game controller 150 for transmission to gaming system 170 in order to update the gaming scenario. Thus, the effector basically requires the user to perform an exercise in order to interact with the gaming scenario.

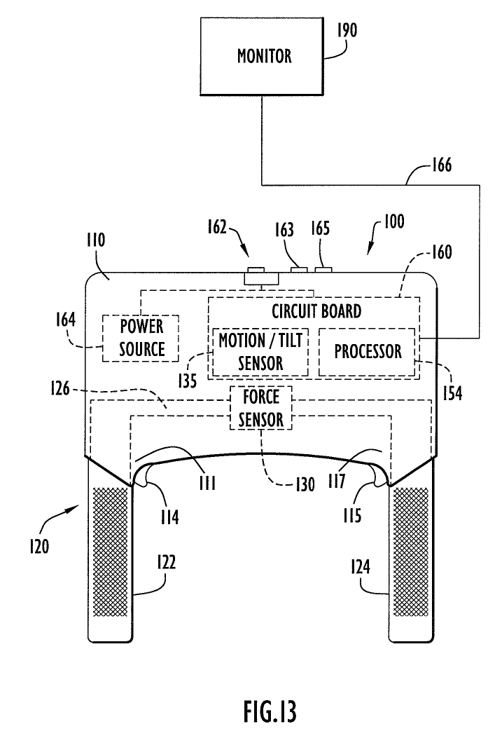

Still another alternative embodiment of the effector for exercise gaming device 100 is illustrated in FIG. 12. Initially, effector 120 is similar to the effectors described above and includes gripping members 222, 224 substantially similar to gripping members 222, 224 described above. The gripping members each include body or handle portion 227 engagable by a user hand and leg portion 228 extending transversely from the body. The gripping members are arranged in an inverted position with bodies 227 substantially parallel. Legs 228 of gripping members 222, 224 are arranged in a criss-cross type configuration with their distal ends slidably secured to a shaft 230, preferably secured within housing 110. A spring 232 is disposed on the shaft between the ends of legs 228, while a spring 234 is disposed on the shaft between leg 228 of gripping member 224 and a stop. The springs provide resistance to user forces applied to the gripping members. The gripping members are preferably constructed of a suitably rigid material (e.g., metal, steel, plastic, rubber, etc.) that is capable of being slightly deflected within its elastic limit in response to any combination of bending, twisting, tension and compression forces applied to the gripping members.

When the user applies a pulling force to gripping members 222, 224, legs 228 of gripping members 222, 224 are urged toward each other along the shaft, thereby compressing spring 232 and expanding spring 234. In response to a pushing force applied to gripping members 222, 224, legs 228 of gripping members 222, 224 are urged away from each other along the shaft, thereby expanding spring 232 and compressing spring 234. The expansion and compression of springs 232, 234 resists the forces applied by the user. Force sensors 130 may be attached to gripping members 222, 224 to measure the applied force (e.g., the deformity of the gripping members). The force measurement is provided to game controller 150 for transmission to gaming system 170 in order to update the gaming scenario. Thus, the effector basically requires the user to perform an exercise in order to interact with the gaming scenario.

Exercise gaming devices 50, 100 may include any combinations of the embodiments and mechanical arrangements providing resistance described above. For example, exercise gaming devices 50, 100 may employ one mechanical arrangement for one effector or gripping member, and utilize the same or different arrangement for the other effector or gripping member (e.g., any combinations of the damping assembly (FIGS. 3-4), the fixedly attached members (FIG. 5), bolt and spring arrangement (FIG. 6), bolt and ring arrangement (FIG. 7), spring arrangement (FIG. 8) or other arrangements (FIGS. 9-12)). Moreover, the force or other sensors may be disposed at any suitable locations (e.g., effector member or corresponding bar, gripping member, intermediate member or bar, compressible ring, bolt, springs, grip portion, divider, chassis, gripping member legs or bodies, pivot member, shaft, resistive member, etc.) to measure the applied force (or compression of the various components, such as compressible rings or springs). In addition, housings 60, 110 of the exercise gaming devices may be configured to accommodate the embodiments with various mechanical arrangements described above.

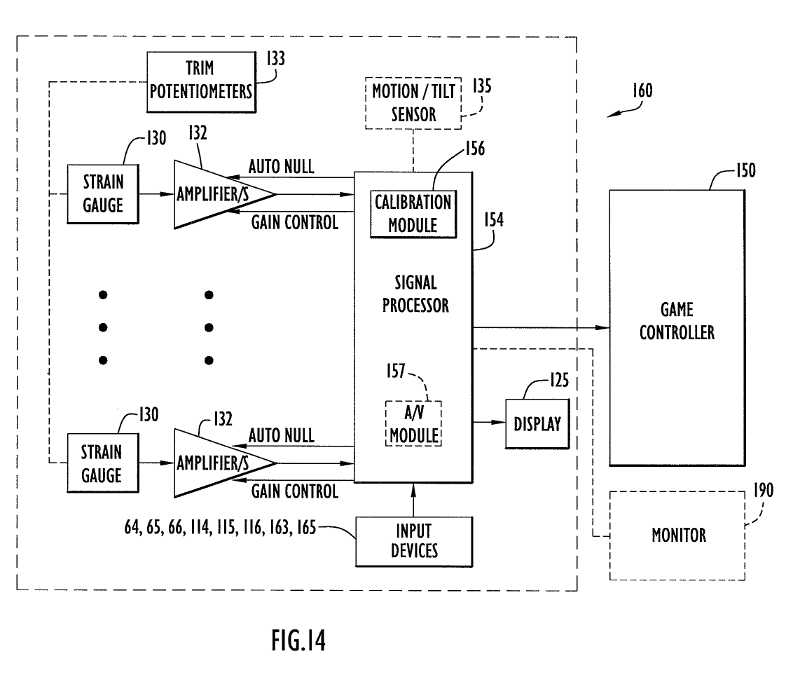

Exercise gaming devices 50, 100 may further provide the computer-generated scenario for display device 190. Referring to FIG. 13, exercise gaming device 100 may be similar to exercise gaming device 100 described above for FIG. 5, and includes control circuitry 160 described below, and housing 110 and effector 120 each as described above. The control circuitry includes a processor 154 (FIG. 14) with various gaming applications, where exercise gaming device 100 is coupled directly to display device 190 by a suitable cable 166 (e.g., conveying analog and/or digital video and/or audio signals, coaxial cables, optical cables, etc.) to display a gaming scenario as described below. The games provided by processor 154 generally include characters or objects that are controlled by a user. For example, the user may control movement and actions of a character or a vehicle (e.g., car, airplane, boat, etc.) to move through a virtual or computer-generated environment displayed on the display device and provided by processor 154.

Housing 110 is generally rectangular with projections 111, 117 disposed toward opposing housing side edges as described above. Effector 120 is generally ‘U’-shaped and includes gripping members 122, 124 rigidly or fixedly attached to opposing ends of intermediate member 126 as described above. The intermediate member is disposed within housing 110, while gripping members 122, 124 respectively extend down from the intermediate member ends through and beyond the open bottom portions of projections 111, 117 as described above. The gripping members extend beyond the open bottom portions of the projections for a distance sufficient to enable a user to grip and apply force to the gripping members. Exercise gaming device 100 (FIG. 13) may be implemented by, or include, any of the configurations described above for exercise gaming devices 50, 100.

The housing includes a power source 164, preferably in the form of one or more batteries. Trigger type input devices 114, 115 are respectively disposed on projections 111, 117 and enable interaction with the computer-generated scenario as described above. In addition, housing 110 may further include a power switch 162 and various input devices (e.g., reset button 163, select buttons 165, etc.) to control power supplied to the control circuitry and enable further interaction with the computer-generated scenario. Control circuitry 160 includes processor 154 and a sensing arrangement 135. The sensing arrangement (e.g., motion or tilt sensor, accelerometer, infrared triangulation system, etc.) measures the orientation (e.g., plural degree-of-freedom, motion along X, Y and Z axes, twist, etc.) of the exercise gaming device. The orientation measurements may be utilized to provide directional controls for the gaming scenario (e.g., steering, etc.). The processor provides the computer-generated gaming scenario displayed on display device 190 and updates that scenario in accordance with user manipulation of gripping members 122, 124, select buttons 165 and the measured orientation of the exercise gaming device as described below.

A user grips and applies force to gripping members 122, 124 in order to direct the gripping members toward (e.g., applying a pushing force) and away (e.g., applying a pulling force) from each other. The amount of force applied to the gripping members controls the gaming scenario displayed on display device 190 and provided by processor 154. This basically requires the user to perform exercise in order to interact with the gaming scenario. Accordingly, housing 110 further includes one or more force sensors 130 preferably disposed on or adjacent intermediate member 126 and/or gripping members 122, 124 as described above. Force sensors 130 measure the force applied by the user to exercise gaming device 100 and provide measurement signals (e.g., analog, digital, etc.) to control circuitry 160 for processing as described below. By way of example, the force sensors measure the amount of a strain deformation applied to the intermediate member as a result of the user applying pushing, pulling or lateral forces to the gripping members as described above.

Processor 154 receives and processes the force and orientation measurements from sensors 130, 135 and the information pertaining to manipulation of triggers 114, 115 and select buttons 165 and updates the gaming scenario displayed on display device 190 in accordance with the received information. Thus, user manipulation of the gripping members enables the user to interact with the gaming scenario (e.g., controls an object or some action in the gaming scenario). In other words, the greater the force applied to exercise gaming device 100, the greater the effect within the gaming scenario. The gaming scenarios utilized with exercise gaming device 100 typically require the user to apply force to the gripping members (e.g., pull, compress, etc.) in a variety of different orientations to access different muscles and achieve goals in the gaming scenario. In addition, exercise gaming device 100 includes a dynamic calibration to control the amount of force required by a user in order to interact with the gaming scenario as described below.

An exemplary control circuit 160 for exercise gaming devices 50, 100 is illustrated in FIG. 14. Specifically, control circuit 160 for interfacing with game controller 150 includes one or more force sensors 130, corresponding amplifiers 132, and processor 154. A conventional power supply (not shown in FIG. 14) provides appropriate power signals to each of the circuit components. The circuit may be powered by a battery and/or any other suitable power source (e.g., the gaming or simulation system). A power switch (not shown in FIG. 14) may further be included to activate the circuit components. Further, the control circuit may include trim potentiometers 133 to adjust the centering and range of the force or strain gauge sensors.

Force sensors 130 are each connected to a respective amplifier 132. The electrical resistance of the force sensors varies in response to compression and stretching (e.g., deformity) of the particular component coupled to the force sensor (e.g., chassis, effector member or corresponding bars, intermediate member, gripping member, intermediate bar, pivot member, etc.). Amplifiers 132 basically amplify the force sensor signals (e.g., in a range compatible with the type of game controller employed). The output signals from the amplifiers basically represent instantaneous strength of the user. The amplified voltage value is sent by each amplifier to processor 154.

Processor 154 may be implemented by any conventional or other processor and may include circuitry and/or convert the analog signals from the amplifiers to digital values for processing. Basically, an amplified sensor value represents the force applied by the user, where values toward the range maximum indicate greater applied force. The amplified analog value is digitized or quantized within a range in accordance with the quantity of bits within the converted digital value (e.g., −127 to +127 for eight bits signed, −32,767 to +32,767 for sixteen bits signed, etc.) to indicate the magnitude and/or direction of the applied force. Thus, amplified voltage values toward the range maximum produce digital values toward the maximum values of the quantization ranges. Alternatively, the force sensors may measure the force and provide digital signals directly to the processor.

The processor includes a calibration module 156 to control the resistance level or amount of force required by the user to interact with the gaming scenario. The calibration module performs a dynamic calibration to adjust the resistance to an appropriate level for each user. In particular, a gaming scenario may initially request the user to apply force to the effector or gripping members of the respective exercise gaming devices 50, 100 (e.g., to pop a displayed balloon, etc.). The calibration module measures the maximum force applied by the user (e.g., when a force measurement remains constant over a certain time interval, etc.) based on the outputs from force sensors 130, and sets the resistance to a certain level relative to the user maximum force or strength (e.g., the upper limit of force for interaction with the gaming scenario may be set to a certain percentage (e.g., seventy to ninety percent) of the user maximum strength). The calibration module may further monitor the user strength during interaction with the gaming scenario and adjust the resistance accordingly (e.g., as the user grows tired or fatigued, etc.).

The processor controls amplifier gain parameters to adjust the required force in accordance with the calibration. In particular, the processor adjusts the gain control of the amplifiers in order to facilitate a resistance level in accordance with the dynamic calibration and/or the computer-generated scenario (e.g., the gaming or simulation may provide a virtual environment or conditions requiring additional or less force to perform an action). The gain control parameter basically controls the amount of gain applied by the amplifier to an amplifier input (or force sensor measurement). Since greater amplified values correspond to a greater force, increasing the amplifier gain enables a user to exert less force to achieve a particular amplified force value, thereby effectively lowering the resistance of the peripheral for the user. Conversely, reducing the amplifier gain requires a user to exert greater force to achieve the particular amplified force value, thereby increasing the resistance of the peripheral for the user. The processor further adjusts an amplifier Auto Null parameter to zero or tare the strain gauge sensors.

The processor receives the amplified sensor values and may determine various information for display to a user on a display 125 of exercise gaming devices 50, 100 (e.g., instantaneous strength as a function of time, the degree of force applied to the effector at any given time, the amount of work performed by the user during a particular session, resistance levels, time or elapsed time, force applied by the user to the various axes (e.g., X, Y, Z and rotational axes), instantaneous force applied, total weight lifted, calories burned (e.g., based on the amount of work performed and user weight), resistance level setting, degree of effector movement and/or any other exercise or other related information). The display may be of any conventional or other type (e.g., LCD, etc.), and may be disposed at any suitable locations on respective housings 60, 110 of exercise gaming devices 50, 100. Alternatively, the information may be forwarded to the gaming system, via game controller 150, for display on display device 190. In addition, the processor receives signals indicating manipulation of triggers 64, 65, 114, 115 and joysticks 66, 116.

The processor processes the received information and transfers the processed information to game controller 150 via appropriate controller peripheral ports (e.g., NINTENDO NUNCHUCK peripheral port). The game controller forwards the information to gaming system 170 to update and/or respond to an executing gaming scenario. Basically, the processor processes and arranges the received information into a format similar to those the game controller receives from corresponding controller peripherals (e.g., NINTENDO NUNCHUCK peripheral). The processor may process raw digital values in any fashion to account for various calibrations or to properly adjust the values within quantization ranges. The game controller receives the information and handles the information in the same manner as information received from a game controller peripheral (e.g., NINTENDO NUNCHUCK peripheral). The information is forwarded to gaming system 170, where the gaming system processes the information to update and/or respond to an executing gaming scenario displayed on display device 190.

In the case of processor 154 including and executing gaming software, control circuitry 160 is substantially similar to and operates in substantially the same manner as the circuit described above, and may receive power from power source 164 (FIG. 13) to provide appropriate power signals to each of the circuit components as described above. The circuit is preferably powered by one or more batteries, but may be powered by other suitable power sources. Power switch 162 (FIG. 13) may further be included to activate the circuit components as described above. Circuit 160 further includes sensing arrangement 135 to measure the orientation (e.g., plural degree-of-freedom, motion along X, Y and Z axes, twist, etc.) of the exercise gaming device. The orientation measurements are provided to processor 154.

Force sensors 130 measure the force applied by the user to gripping members 122, 124 and provide the force measurements to processor 154 via amplifiers 132 as described above. Processor 154 executes a gaming scenario for display on display device 190. The processor processes the received signals and updates the executing gaming scenario in accordance with the force and orientation measurements (e.g., manipulation of the exercise gaming device, gripping members, etc.) and/or manipulation of the input mechanisms (e.g., triggers 114, 115, select buttons 165, etc.). The processor may control the resistance level or amount of force required by the user to interact with the gaming scenario via calibration module 156. The calibration module performs a dynamic calibration to adjust the resistance to an appropriate level for each user as described above.

The processor may include, or be coupled to, an audio/visual (A/V) module 157 that generates signals (e.g., video, audio, etc.) for transference from exercise gaming device 100 directly to display device 190. The A/V module may be implemented by any conventional or other processing system or circuitry (e.g., video processor, digital processor (DSP), etc.) providing audio and/or video signals. The signals may be provided to the display device via cable 166 (FIG. 13) connected to and extending from the housing upper portion or any other suitable location. The cable may be implemented by any conventional or other cable suitable to transfer video and/or audio signals. By way of example, a user may connect the interface device directly to a television set or other monitor through either an RF connector (e.g., via channels three or four), or through the monitor audio/visual ports (e.g., via RCA type connectors, etc.). In addition, the processor performs a reset or reboot operation in response to actuation of reset button 163 (FIG. 13).

Operation of exercise gaming devices 50, 100 is described with reference to FIGS. 1-14. Initially, the user inserts game controller 150 within controller port 62, 112 to respectively couple exercise gaming device 50, 100 to gaming system 170. A game is selected and executed on the gaming system, and the user engages in an exercise to interact with the game. In the case of processor 154 providing the gaming scenario, the exercise gaming device is directly coupled to display device 190 and a game is selected by the user.

During an initial calibration, the user may be requested to apply force to the effector or gripping members of exercise gaming device 50, 100, respectively. Calibration module 156 determines the maximum force applied and sets the resistance of exercise gaming device 50, 100 to an appropriate level for the user as described above. The calibration module may further monitor the applied force to control the resistance level during the gaming scenario.

The user operates exercise gaming device 50, 100 by applying pushing, pulling or other forces to effector members 72, 74 or effector 120, respectively. The user may apply one or more forces to the effector or gripping members with respect to at least one of the axes to effect corresponding movement, for example, of a character or an object in the gaming scenario displayed by the gaming system. The user may further manipulate the triggers, joystick and other input devices of exercise gaming device 50, 100 for additional actions depending upon the particular gaming scenario.

The signals from the force sensors and input devices (e.g., triggers, joystick, etc.) are transmitted to control circuit 160 for processing and formatting of the information in an appropriate manner for transference to game controller 150 as described above. The game controller forwards the received information (and any orientation or input device (e.g., input devices 152) information measured by the game controller) to gaming system 170. The gaming system processes the forwarded information to update and/or respond to an executing gaming scenario. In the case of processor 154 providing the gaming scenario, the processor processes the received information (e.g., received from the force sensors, sensing arrangement, triggers, select and reset buttons, etc.) to update the gaming scenario displayed on display device 190. Thus, the force applied by the user to exercise gaming devices 50, 100 results in a corresponding coordinate movement or action in the gaming scenario displayed on display device 190. In other words, user exercise serves to indicate desired user actions or movements to the gaming system to update movement or actions of characters or objects within the gaming scenario.

It will be appreciated that the embodiments described above and illustrated in the drawings represent only a few of the many ways of implementing an exercise gaming device and method of facilitating user exercise during video game play.

Exercise gaming device 50 and corresponding components (e.g., effector members, damping assembly, housing, coverings, bars, etc.) may be of any size or shape, may be arranged in any fashion and may be constructed of any suitable materials. Exercise gaming device 50 may be a hand-held unit or be mounted to any suitable support or surface. The controller port of exercise gaming device 50 may be of any quantity, shape or size, may be disposed at any suitable locations and may be configured for any suitable game or other controller or peripheral device. Alternatively, exercise gaming device 50 may be configured for direct communication (e.g., wired, wireless, etc.) with the gaming or simulation system (e.g., without use of an embedded controller). Exercise gaming device 50 may include any quantity of any types of input devices disposed at any suitable locations (e.g., buttons, switches, slides, joysticks, etc.). The display may be of any quantity, shape or size, may be implemented by any conventional or other type of display (e.g., LCD, etc.), and may be disposed at any suitable locations on the housing of exercise gaming device 50. The housing of exercise gaming device 50 may be configured in any fashion to accommodate the embodiments with the fixed effector members and/or various mechanical damping arrangements described above.

The housing and shell members of exercise gaming device 50 may be of any quantity, shape or size and may be constructed of any suitable materials. The shell members may be coupled together via any suitable fastening techniques (e.g., fasteners, adhesives, mated parts, etc.) and encompass any exercise gaming device components. The shell members may be configured in any fashion to accommodate any peripheral components (e.g., controller port, etc.). The shell member recesses may be of any quantity, shape or size and may be disposed in the shell member at any suitable locations. The shell member channels may be of any quantity, shape or size and may be disposed in the shell member or recesses at any suitable locations.

The effector coverings may be of any quantity, shape or size and may be constructed of any suitable materials. The effector coverings may be coupled together via any suitable fastening techniques (e.g., fasteners, adhesives, mated parts, posts, etc.) and encompass any exercise gaming device components. The effector coverings may be configured in any fashion to accommodate any peripheral components (e.g., trigger, joystick, etc.). The effector coverings may include any quantity of posts of any shape or size and disposed at any suitable locations. The posts may include any quantity of channels or openings of any shape or size to accommodate any suitable fasteners. The effector covering body and upper portions may be of any shape or size, where the upper portion may include any suitable configuration for compatibility with the shell member recess channel. The effector coverings may alternatively be employed with any suitable mechanisms to enable movement of the effector members.

The damping assembly may include any quantity of bars constructed of any suitable materials, preferably those that are subject to measurable deflection within an elastic limit of the materials when subjected to one or more straining or other forces by the user (e.g., metal, plastic, rubber, etc.). The bars may be of any size, have any suitable geometric configurations (e.g., rectangular, cylindrical, etc.) and be secured at any suitable locations via any fastening techniques (e.g., fasteners, etc.). The effector members (or effector coverings) may include a treated portion to enhance gripping by a user (e.g., ridges or other embedded deformity, gripping material, etc.).

The chassis may be of any quantity, shape or size and may be constructed of any suitable materials, preferably those that are subject to measurable deflection within an elastic limit of the materials when subjected to one or more straining or other forces (e.g., metal, plastic, rubber, etc.). The chassis may include openings of any quantity, shape or size disposed at any suitable locations to secure damping assembly components. The front, rear and top panels may be of any quantity, shape or size and may be constructed of any suitable materials. The panels may be arranged in any fashion for the chassis. The stop flange and corresponding projections may be of any quantity, shape or size and may be disposed at any suitable locations. The dowel pin may be of any quantity, shape or size, may be constructed of any suitable materials and may be disposed at any suitable locations. The chassis projections may be of any quantity, shape or size and be disposed at any locations to receive and secure the bars.

The damping assembly washers may be of any quantity, shape or size, may be constructed of any suitable materials (e.g., metal, plastic, etc.) and may be disposed at any suitable locations. The washers may include openings of any quantity, shape or size disposed at any suitable locations. The damping assembly nuts and bolt may be implemented by any conventional or other securing mechanisms, and may be of any size or shape. The compressible rings of the damping assembly may be constructed of any suitable compressible or resilient materials (e.g., rubber, urethane, etc.), may be of any quantity, size or shape and may be disposed at any suitable locations. The divider of the damping assembly may be constructed of any suitable materials (e.g., metal, plastic, etc.), may be of any quantity, size or shape and may be disposed at any suitable locations. The divider may be movably or fixedly secured to the chassis via any fastening techniques (e.g., fasteners, adhesives, etc.). The divider and rings may include openings of any quantity, shape or size disposed at any suitable locations. Alternatively, the damping assembly may include any suitable compressible device (e.g., rubber, springs, resilient members, etc.) to provide the resistance. The bars may be attached to the chassis (e.g., without the damping assembly) via any conventional or other techniques (e.g., projection and notch, securing mechanisms, etc.) to directly apply force to the chassis and provide an isometric exercise.

Exercise gaming device 50 may include any combinations of the embodiments and mechanical arrangements providing resistance described above. For example, one mechanical arrangement may be utilized for one effector member, while the same or different arrangement may be utilized for the other effector member. Further, exercise gaming device 50 may provide a gaming scenario to a display device in substantially the same manner described above.

Any suitable number of any types of sensors (e.g., strain gauges, etc.) may be applied to the effector members, bars and/or chassis to facilitate the measurement of any one or more types of strain or other forces applied by the user (e.g., bending forces, twisting forces, compression forces and/or tension forces). The sensors may be constructed of any suitable materials, may be disposed at any locations and may be of any suitable type (e.g., strain gauge, etc.). Further, the sensors may include any electrical, mechanical or chemical properties that vary in a measurable manner in response to applied force to measure force applied to an object. The sensors may include any desired arrangement and be disposed at any locations on any of the components (e.g., effector members, chassis, bars, compressible rings, divider, etc.). Exercise gaming device 50 may be configured to accommodate any suitable quantity of force applied by a user. The sensing arrangement may be implemented by any quantity of any conventional or other sensors (e.g., accelerometer, infrared triangulation system, etc.) to measure the orientation (e.g., plural degree-of-freedom, etc.) of the game controller or exercise gaming device. The sensing arrangement may be disposed at any suitable locations on or within the game controller and/or exercise gaming device.

Exercise gaming device 100 and corresponding components (e.g., effector, housing, etc.) may be of any size or shape, may be arranged in any fashion and may be constructed of any suitable materials. Exercise gaming device 100 may be a hand-held unit or be mounted to any suitable support or surface. The housing of exercise gaming device 100 may be of any shape or size and may be constructed of any suitable materials. The housing projections may be of any quantity, shape or size and may be disposed at any suitable locations on the housing. The controller port of exercise gaming device 100 may be of any quantity, shape or size, may be disposed at any suitable locations and may be configured for any suitable game or other controller or peripheral device. Alternatively, exercise gaming device 100 may be configured for direct communication (e.g., wired, wireless, etc.) with the gaming or simulation system (e.g., without use of an embedded controller). The housing of exercise gaming device 100 may include any quantity of any types of input devices disposed at any suitable locations (e.g., buttons, switches, slides, joysticks, etc.). The display may be of any quantity, shape or size, may be implemented by any conventional or other type of display (e.g., LCD, etc.), and may be disposed at any suitable locations on the housing of exercise gaming device 100. The housing of exercise gaming device 100 may be configured in any fashion to accommodate the various embodiments of the effector described above.

The effector of exercise gaming device 100 may be constructed of any suitable materials, preferably those that are subject to measurable deflection within an elastic limit of the materials when subjected to one or more straining or other forces by the user (e.g., metal, plastic, rubber, etc.). The effector may have any suitable geometric configurations (e.g., rectangular, cylindrical, etc.). The gripping members, intermediate members and pivot member of exercise gaming device 100 may be of any quantity, shape or size, may be constructed of any suitably sturdy materials (e.g., metal, plastic, etc.) and may be arranged in any suitable configuration (e.g., U-shape, etc.). The gripping members may include a treated portion to enhance gripping by a user (e.g., ridges or other embedded deformity, gripping material, etc.).

The projections of intermediate member 126 may be of any quantity, shape or size and may be disposed at any suitable locations. The intermediate member projections and gripping members 122, 124 may include openings of any quantity, shape or size disposed at any suitable locations. The washers of exercise gaming device 100 may be of any quantity, shape or size, may be constructed of any suitable materials (e.g., metal, plastic, etc.) and may be disposed at any suitable locations. The washers of exercise gaming device 100 may include openings of any quantity, shape or size disposed at any suitable locations. The nut and bolt of exercise gaming device 100 may be implemented by any conventional or other securing mechanisms, and may be of any size or shape. The compressible ring of exercise gaming device 100 may be constructed of any suitable compressible or resilient materials (e.g., rubber, etc.), may be of any quantity, size or shape and may be disposed at any suitable locations. The springs of exercise gaming device 100 may be constructed of any suitable materials (e.g., metal, etc.), may be of any quantity, size or shape and may be disposed at any suitable locations. The springs may include any desired quantity of coils to provide a desired resistance. Alternatively, the mechanical arrangement of exercise gaming device 100 may include any suitable compressible device (e.g., rubber, springs, resilient members, etc.) to provide the resistance. The gripping members may be attached to the intermediate member via any conventional or other techniques (e.g., projection and notch, securing mechanisms, etc.).

The intermediate bar of exercise gaming device 100 may be of any quantity, shape or size, may be constructed of any suitable materials (e.g., metal, plastic, etc.) and may be disposed at any suitable locations. The springs of exercise gaming device 100 may be coupled to the intermediate bar via any conventional or other techniques (e.g., welded, securing mechanisms, etc.). The springs may be constructed of any suitable materials (e.g., metal, etc.), may be of any quantity, size or shape and may be disposed at any suitable locations. The springs may include any desired quantity of coils and oriented in any suitable fashion to provide a desired resistance. The grip portions may be of any quantity, shape or size, may be constructed of any suitable materials and may be disposed at any suitable locations. The grip portions may include a treated portion to enhance gripping by a user (e.g., ridges or other embedded deformity, gripping material, etc.), or be constructed of or covered with a suitable gripping material (e.g., rubber, etc.).

The gripping member body and legs may be of any quantity, shape or size, may be constructed of any suitably sturdy materials (e.g., metal, plastic, etc.) and may be arranged in any suitable configuration (e.g., L-shape, etc.). The gripping members (and/or legs) may be oriented in any desired fashion relative to each other (e.g., criss-cross, overlapping, mated, etc.). The slots may be of any quantity, shape or size, and may be disposed at any suitable locations. The slots may receive any quantity of any types of suitable fasteners of any shape or size. The springs (e.g., upper, lower, torsion, etc.) may be constructed of any suitable materials (e.g., metal, etc.), may be of any quantity, size or shape and may be disposed at any suitable locations. The springs may include any desired quantity of coils and be oriented in any suitable fashion to provide a desired resistance. The resistive member may include any suitable resistive device (e.g., torsion or other spring, any quantity or types of gears, etc.) to resist user applied forces to the gripping members and may be disposed at any suitable locations (e.g., the legs may be oriented in any fashion relative to each other, etc.). The shaft may be of any quantity, shape or size and may be disposed at any suitable location within a housing. The shaft may accommodate any quantity of springs or other resistive devices.

The effector of exercise gaming device 100 may include any combinations of the embodiments and mechanical arrangements providing resistance described above. For example, the effector may employ one mechanical arrangement for one gripping member, and utilize the same or different arrangement for the other gripping member (e.g., any combinations of the fixedly attached members (FIG. 5), bolt and spring arrangement (FIG. 6), bolt and ring arrangement (FIG. 7), spring arrangement (FIG. 8) or other arrangements (FIGS. 9-12)). The gripping members may alternatively be directly and fixedly or movably (e.g., with or without a damping mechanism or mechanical arrangement to provide resistance) attached to each other. Exercise gaming devices 100 may provide the gaming scenario to a display device in substantially the same manner described above.

Any suitable number of any types of sensors (e.g., strain gauges, etc.) may be applied to the effector of exercise gaming device 100 to facilitate the measurement of any one or more types of strain or other forces applied by the user (e.g., bending forces, twisting forces, compression forces and/or tension forces). The sensors may be constructed of any suitable materials, may be disposed at any locations and may be of any suitable type (e.g., strain gauge, etc.). Further, the sensors may include any electrical, mechanical or chemical properties that vary in a measurable manner in response to applied force to measure force applied to an object. The sensors may include any desired arrangement and be disposed at (or coupled to) any locations on any effector components (e.g., gripping members, intermediate members and bar, springs, compressible ring, grip portions, pivot and resistive members, shaft, etc.). Exercise gaming device 100 may be configured to accommodate any suitable quantity of force applied by a user. The sensing arrangement may be implemented by any quantity of any conventional or other sensors (e.g., accelerometer, infrared triangulation system, etc.) to measure the orientation (e.g., plural degree-of-freedom, etc.) of the game controller or exercise gaming device. The sensing arrangement may be disposed at any suitable locations on or within the game controller and/or exercise gaming device.

The processor may be implemented by any quantity of any type of microprocessor, processing system or other circuitry, while the control circuit may be disposed at any suitable locations on the housing. The control circuit and/or processor may be connected to the game controller via any suitable peripheral, communications media or port. The processor may further arrange data (e.g., force or other measurements by sensors, input device information, etc.) into any suitable format that is recognizable by the game controller. The information may include any desired information and be arranged in any desired format. The information from the processor may be relayed to the game controller via any suitable ports (e.g., peripheral ports, data ports, etc.). Alternatively, the information may be directly communicated to the gaming system.

The processor may include and execute any desired gaming or other applications. The A/V module may be implemented by any quantity of any conventional or other processing system or circuitry (e.g., video processor, digital signal processor (DSP), etc.) providing audio and/or video signals. The exercise gaming device may be coupled directly to a display device via any conventional or other cable or connectors (e.g., RF, RCA type, etc.). The exercise gaming device may be configured to be selectively coupled to either a display device or a gaming processor (e.g., via a cable or game controller). In this case, the exercise device may include input devices to enable a user to indicate the manner of use.

The calibration may utilize any suitable techniques to determine maximum strength or other user characteristics (e.g., average strength, endurance, etc.) from the force measurements and other information. The resistance levels may be set to any desired proportion of the user characteristics (e.g., a certain proportion of the maximum strength, etc.). The calibration may monitor the force measurements at any desired time intervals (e.g., seconds, minutes, etc.) to adjust resistance for the user. The gaming system may provide any desired scenario for the initial calibration (e.g., inflate a balloon, make an object move, etc.).

Any suitable number of any types of conventional or other circuitry may be utilized to implement the control circuit, amplifiers, sensors, trim potentiometers, and processor. The amplifiers may produce an amplified value in any desired voltage range, while the A/D conversion may produce a digitized value having any desired resolution or quantity of bits (e.g., signed or unsigned). The control circuit may include any quantity of the above or other components arranged in any fashion. The resistance change of the sensors may be determined in any manner via any suitable conventional or other circuitry. The amplifiers and processor may be separate within a circuit or integrated as a single unit. Any suitable number of any type of conventional or other displays may be connected to the processor, where the processor may provide any type of information relating to a particular session (e.g., results from exercises including force and work, calories burned, weight lifted, etc.).

The gaming system may be implemented by any quantity of any personal or other type of computer or processing system (e.g., IBM-compatible, Apple, Macintosh, laptop, palm pilot, microprocessor, gaming consoles such as the Xbox system from Microsoft Corporation, the PlayStation 2 system from Sony Corporation, the GameCube system or Wii system from Nintendo of America, Inc., etc.). The game controller may be implemented by any suitable peripherals for these types of systems. The gaming system may be a dedicated processor or a general purpose computer system (e.g., personal computer, etc.) with any commercially available operating system (e.g., Windows, OS/2, Unix, Linux, etc.) and/or commercially available and/or custom software (e.g., communications software, application software, etc.) and any types of input devices (e.g., keyboard, mouse, microphone, etc.). The gaming system may execute software from a recorded medium (e.g., hard disk, memory device, CD, DVD or other disks, etc.) or from a network or other connection (e.g., from the Internet or other network).

Any suitable number of any type of conventional or other displays may be connected to the exercise gaming devices or gaming system to provide any type of information relating to a particular computer session. A display may be located at any suitable location local or remote from the gaming system.

It is to be understood that the software (e.g., calibration module, etc.) of the exercise gaming devices (e.g., processor, etc.) may be implemented in any desired computer language, and could be developed by one of ordinary skill in the computer and/or programming arts based on the functional description contained herein. Further, any references herein of software performing various functions generally refer to computer systems or processors performing those functions under software control. The processing of the exercise gaming devices may be implemented by any hardware, software and/or processing circuitry, or may be implemented on the gaming system or host system as software and/or hardware modules receiving the sensor and/or input device information or signals. The various functions of the processors (e.g., processor 154, game, etc.) may be distributed in any manner among any quantity (e.g., one or more) of hardware and/or software modules or units, processors, computer or processing systems or circuitry, where the processors, computer or processing systems or circuitry may be disposed locally or remotely of each other and communicate via any suitable communications medium (e.g., LAN, WAN, Intranet, Internet, hardwire, modem connection, wireless, etc.). The software and/or algorithms described above may be modified in any manner that accomplishes the functions described herein.

The terms “upward”, “downward”, “top”, “bottom”, “side”, “front”, “rear”, “upper”, “lower”, “vertical”, “horizontal”, “height”, “width”, “length”, “forward, “backward”, “left”, “right” and the like are used herein merely to describe points of reference and do not limit the present invention to any specific orientation or configuration.

The exercise gaming device of the present invention embodiments is not limited to the gaming applications described above, but may be utilized with any processing system, software or application. The exercise gaming device may be utilized for interaction with any type of computer-generated scenario (e.g., providing only video for interaction, providing only audio for interaction, providing video and audio, etc.). The exercise gaming devices (e.g., gripping members, orientation, etc.) may be utilized for any desired actions within the simulation, gaming or other computer-generated scenarios (e.g., directional, speed or rate, control, actuation of events, various motions or actions (e.g., throwing, rolling, swinging a sport or other item (e.g., bat, racquet, etc.), response to prompts, etc.).

From the foregoing description, it will be appreciated that the invention makes available a novel exercise gaming device (or apparatus) and method of facilitating user exercise during video game play, wherein an exercise gaming device for a gaming or simulation system enables users to interact with video games or simulations and exercise during game play or simulation interaction.

Having described preferred embodiments of a new and improved exercise gaming device and method of facilitating user exercise during video game play, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. An apparatus to manipulate a computer-generated scenario comprising:
a hand-held device including:
a plurality of force members each engagable by a corresponding user hand to receive forces applied thereto, wherein said force members are coupled to each other and said applied force effects a measurable deformity within a portion of said hand-held device;
at least one force sensor to measure said deformity to determine said forces applied by said user hands; and
a processor to process measurements from said at least one force sensor and facilitate interaction with said computer-generated scenario in accordance with said applied forces.

2. The apparatus of claim 1, wherein said hand-held device further includes:
a body member disposed between and coupled to said force members, wherein said applied forces effect a deformity of at least one of said body member and at least one force member that is measurable by said at least one force sensor.

3. The apparatus of claim 1, wherein said hand-held device further includes:
a damping mechanism to provide resistance to said force members and resist said forces applied by said user hands.

4. The apparatus of claim 2, wherein said hand-held device further includes a damping mechanism to provide resistance to said force members and resist said forces applied by said user hands, and wherein said damping mechanism includes one of a compressible material and a spring that are compressed in response to user manipulation of said force members to provide said resistance.

5. The apparatus of claim 1, wherein said computer-generated scenario is provided by a processing system including a controller device to control said computer-generated scenario, and said hand-held device further includes:
a controller port to receive said controller device therein, wherein said controller device communicates with said processing system and said processor transfers information to said controller device for transference to said processing system to control said computer-generated scenario of said processing system in accordance with said applied forces.

6. The apparatus of claim 1, wherein hand-held device further includes:
at least one orientation sensor to measure orientation of said hand-held device, wherein said processor processes measurements from said orientation and force sensors and facilitates control of said computer-generated scenario in accordance with said applied forces and measured orientation.

7. The apparatus of claim 2, wherein said plurality of force members are each one of fixedly attached to said body member and coupled to said body member via a spring.

8. The apparatus of claim 1, wherein said processor includes:
a calibration module to measure said forces applied to said force members and set an amount of force required by said user to be applied to said force members in order to interact with said computer-generated scenario.

9. The apparatus of claim 8, wherein said calibration module sets said required force to be a percentage of a user maximum strength determined from said measured forces.

10. The apparatus of claim 8, wherein said calibration module monitors said measured forces during interaction with said computer-generated scenario and dynamically adjusts said required force in accordance with said monitored forces.

11. The apparatus of claim 1, wherein said hand-held device includes a display to display information pertaining to exercise performed by said user.

12. The apparatus of claim 1, wherein said processor produces said computer-generated scenario, and wherein said processor processes measurements from said at least one force sensor and updates said computer-generated scenario in accordance with said measurements.

13. The apparatus of claim 1, wherein said computer-generated scenario includes one of a simulation and a gaming scenario, and said hand-held device further includes at least one input device including at least one of a button, trigger and joystick to interact with said computer-generated scenario.

14. A method of manipulating a computer-generated scenario comprising:
(a) receiving forces applied to a hand-held device including a plurality of force members each engagable by a corresponding user hand to receive forces applied thereto, wherein said force members are coupled to each other and said applied forces effect a measurable deformity within a portion of said hand-held device;
(b) measuring said deformity to determine said forces applied by said user hands via at least one force sensor; and
(c) processing measurements from said at least one force sensor, via a processor, and facilitating interaction with said computer-generated scenario in accordance with said applied forces.

15. The method of claim 14, wherein step (a) further includes:
(a.1) providing resistance to said force members via a damping mechanism to resist said forces applied by said user hands.

16. The method of claim 15, wherein said hand-held device further includes a body member disposed between and coupled to said force members, and wherein said applied forces effect a deformation of at least one of said body member and at least one force member that is measurable by said at least one force sensor, and step (a.1) further includes:
(a.1.1) providing said resistance via one of a compressible material and a spring that are compressed in response to user manipulation of said force members.

17. The method of claim 14, wherein said computer-generated scenario is provided by a processing system including a controller device to control said computer-generated scenario and said hand-held device further includes a controller port, and step (c) further includes:
(c.1) receiving said controller device within said controller port, wherein said controller device communicates with said processing system; and
(c.2) transferring information from said processor to said controller device for transference to said processing system to control said computer-generated scenario in accordance with said applied forces.

18. The method of claim 14, wherein step (b) further includes:
(b.1) measuring an orientation of said hand-held device via at least one orientation sensor; and
step (c) further includes:
(c.1) processing measurements from said orientation and force sensors, via said processor, and facilitating control of said computer-generated scenario in accordance with said applied forces and measured orientation.

19. The method of claim 14, wherein said hand-held device further includes a body member disposed between and coupled to said force members, wherein said applied forces effect a deformation of at least one of said body member and at least one force member that is measurable by said at least one force sensor, and wherein said plurality of force members are each one of fixedly attached to said body member and coupled to said body member via a spring.

20. The method of claim 14, wherein step (c) further includes:
(c.1) measuring said forces applied to said force members and setting an amount of force required by said user to be applied to said force members in order to interact with said computer-generated scenario.

21. The method of claim 20, wherein step (c.1) further includes:
(c.1.1) setting said required force to be a percentage of a user maximum strength determined from said measured forces.

22. The method of claim 20, wherein step (c) further includes:
(c.2) monitoring said measured forces during interaction with said computer-generated scenario and dynamically adjusting said required force in accordance with said monitored forces.

23. The method of claim 14 further including:
(d) displaying information pertaining to exercise performed by said user on a display.

24. The method of claim 14, wherein said processor produces said computer-generated scenario, and step (c) further includes:
(c.1) processing measurements from said at least one force sensor and updating said computer-generated scenario in accordance with said measurements via said processor.

25. The method of claim 14, wherein said computer-generated scenario includes one of a simulation and a gaming scenario, and wherein said hand-held device further includes at least one input device including at least one of a button, trigger and joystick to interact with said computer-generated scenario.
